(19) United States
(12) Patent Application Publication
(10) Pub. No.: US 2009/0273834 A1
(43) Pub. Date: Nov. 5, 2009

(54) STEREOSCOPIC IMAGE DISPLAY APPARATUS

(75) Inventor: Tsuguhiro Korenaga, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/307,851

(22) PCT Filed: May 12, 2008
(86) PCT No.: PCT/JP2008/001187

§ 371 Date: Jan. 7, 2009

(30) Foreign Application Priority Data
May 18, 2007 (JP) 2007-133276

(51) Int. Cl. G02B 27/22

(52) U.S. Cl. 359/463

(57) ABSTRACT

A stereoscopic image display apparatus includes a synthetic image (10) formed by synthesizing a plurality of original images from different viewing points, a lens array (12), and a diffraction element array (11) having the same pitch as the lens array. The diffraction element array has a layer (11a) made of a first material and a layer (11b) made of a second material and includes a blazed diffraction grating pattern with a depth d that is formed at an interface between the layer made of the first material and the layer made of the second material. When the refractive index of the first material and the refractive index of the second material are expressed as functions of an arbitrary wavelength λ in the visible light range as n1(λ) and n2(λ), respectively, the depth d is substantially equal to λ/|n1(λ)−n2(λ)|. Thus, the stereoscopic image display apparatus reduces color misregistration of images associated with chromatic aberration and is therefore capable of displaying high-resolution, wide-viewing-angle, and bright images.

### TECHNICAL FIELD

The present invention relates to a stereoscopic image display apparatus capable of displaying high-quality and wide-field images.

### BACKGROUND ART

Displays and printed matters usually are constituted by a plurality of pixels arranged in a plane, but can be recognized by an observer as stereoscopic information (stereoscopic images) with some contrivance, and thus the realistic sensation and the recognition accuracy can be improved. The observer recognizes a relatively nearby object as three-dimensional by the difference between images seen by the right eye and the left eye. This difference between the images seen by the right eye and the left eye is called stereoscopic parallax. Conventionally, there have been proposed various types of stereoscopic image display apparatuses that use this property and project two images (images with stereoscopic parallax) from different viewing points onto the right and left eyes, respectively, thereby enabling the observer to recognize the images as a stereoscopic image.

However, in order to spread the use of stereoscopic image display apparatuses, the stereoscopic image display apparatuses are required not to be inconvenient to use and not to fatigue the observer even after prolonged viewing. Therefore, approaches of using special tools such as glasses cannot be employed except for special applications. In order to display a stereoscopic image without using these tools, it is necessary to devise some method to present different images to the right and left eyes.

FIG. 10 is a perspective view for explaining the positional relationship between an image and the observer. Reference numeral 80 denotes a display screen on which a stereoscopic image is displayed, and the display screen 80 is in a YZ plane. The observer sees the display screen 80 from a viewing position 81 spaced from the display screen 80 in an X-axis direction. Reference numerals 81a and 81b respectively denote the positions of the right eye and the left eye of the observer, and these positions are in an XY plane. The right eye 81a and the left eye 81b see the display screen 80 at different angles (line-of-sight angles). Therefore, if different images can be displayed for the right eye 81a and the left eye 81b by using the difference in the line-of-sight angle, the observer can recognize the images displayed on the display screen 80 as a stereoscopic image.

FIG. 11 is a diagram for explaining the principle of stereoscopic image display by a parallax barrier method. A light-shielding barrier 90 in which a large number of thin slits (gaps), extending in a direction (a direction parallel to the Z axis) perpendicular to a direction (a direction parallel to the Y axis) in which the right and left eyes 81a and 81b are arranged, are formed is disposed in front of a screen 91. Through the slits of the light-shielding barrier 90, the right eye 81a observes only stripes R of the screen 91, and the left eye 81b observes only stripes L of the image 91. Thus, images with stereoscopic parallax can be presented to the right and left eyes 81a and 81b by dividing an image seen by the right eye into stripes and placing the stripes in respective stripes R and dividing an image seen by the left eye into stripes and placing the stripes in respective stripes L. This method has a problem of darkening of images due to the light-shielding barrier 90.

A method using a lenticular lens array has been proposed as a method that addresses this problem. This method will be described using FIG. 12. A lenticular lens array 100 in which a large number of cylindrical lenses (lenticular lenses) are arranged side by side parallel to the Z axis is disposed in front of a screen 101. When the screen 101 is observed with the right and left eyes arranged in a direction parallel to the Y axis through the lenticular lens array 100, the right and left eyes observe different positions on the screen 101. Therefore, images with stereoscopic parallax can be presented to the right and left eyes by dividing an image seen by the right eye into stripes and placing the stripes in respective positions seen by the right eye and dividing an image seen by the left eye into stripes and placing the stripes in respective positions seen by the left eye.

The parallax barrier method and the lenticular lens array method have a problem in that there is a limitation on the observing position in the Y-axis direction. However, this problem can be alleviated by disposing images from multiple viewing points so that the images are associated with each single slit of the light-shielding barrier 90 or each single lenticular lens and thus enabling viewing at multiple line-of-sight angles. For example, as shown in FIG. 12, when images from three different viewing points are each divided into stripes and the stripes are arranged so that one each stripe of the three images is associated with a single lenticular lens, an eyeball 102a observes only stripes A of the screen 101, an eyeball 102b observes only stripes B of the screen 101, and an eyeball 102c observes only stripes C of the screen 101.

The method of using images from multiple viewing points can deal with situations where the right and left eyes move in a horizontal direction (the Y-axis direction) with respect to the screen. However, the method cannot deal with situations where the right and left eyes rotate around the X axis with respect to the screen, and therefore cannot display a stereoscopic image.

An integral photography method is known as a method by which a stereoscopic image can be observed even in the case where the right and left eyes rotate with respect to the image. In this method, a microlens array in which minute lenses (microlenses) 110 as shown in FIG. 13 are arranged in vertical and horizontal directions is used. Circular lenses, fly's eye lenses, or the like having a light-collecting effect in every direction are used as the microlenses 110, so that different images can be seen at different line-of-sight angles in every direction. With such a microlens array, light rays can be reproduced as if an object was spatially present, and a stereoscopic image can be displayed even in the case where the line of sight rotates. In this manner, the integral photography method can eliminate or reduce the restrictions on the viewing position with respect to the stereoscopic image.

Patent Document 1 discloses a lens array for use in a stereoscopic image display apparatus employing such an integral photography method. Specifically, Patent Document 1 discloses that spherical aberration is reduced by using lenses having an aspherical shape as the lenses constituting the lens array, lens aberration is reduced by increasing the F number of each lens and decreasing the angle of refraction of light rays in the periphery of the lens, and consequently, deterioration in the resolution of a stereoscopic image can be minimized.

On the other hand, Patent Document 2 discloses a display apparatus switchable between two-dimensional image display and stereoscopic image display by combining a lenticular lens array with a material, such as liquid crystal, having an electro-optic effect. FIG. 14 is a cross-sectional view schematically showing the structure of a portion of the lenticular lens array of this display apparatus. A lenticular lens array 120 having a plurality of mutually parallel cylindrical concave faces formed by molding a transparent polymer material and a transparent plate 123 are disposed facing each other. A transparent electrode layer 121a is formed on a surface (a surface in which the plurality of cylindrical concave faces are formed) of the lenticular lens array 120 on the plate 123 side, and a transparent electrode layer 121b is formed on a surface of the plate 123 on the lenticular lens array 120 side. The space between the lenticular lens array 120 and the plate 123 is filled with a liquid crystal material 122. The lens action of the lenticular lens array 120 can be switched by switching on and off the potential difference applied across the transparent electrodes 121a and 121b. For example, the material of the lenticular lens array 120 and the liquid crystal material 56 are selected so that the refractive index of the liquid crystal material 122 and the refractive index of the lenticular lens array 120 are the same in an “off” mode and are different in an “on” mode. In this case, in the “off” mode, the lens action of the lenticular lens array 120 is removed, and the portion of the lenticular lens array 120 and liquid crystal material 122 functions as merely a transparent sheet, so that ordinary two-dimensional image display can be performed. On the other hand, in the “on” mode, there is a difference in the refractive index between the liquid crystal material 122 and the lenticular lens array 120, and the lens action occurs. Thus, light from each pixel (not shown) adjacent to a lenticular lens is directed to a predetermined direction, so that stereoscopic image display can be performed.

Usually, when a two-dimensional image is displayed with a stereoscopic image display apparatus in which a lenticular lens array is used, the resolution of the two-dimensional image deteriorates. However, the display apparatus in which the lenticular lens array in FIG. 14 is used displays a two-dimensional image without a decrease in the resolution due to the lenticular lens array. Moreover, the display screen can be divided into a plurality of regions, and a two-dimensional image and a stereoscopic image can be shown simultaneously in different regions.
Patent Document 1: JP 2005-182073 A
Patent Document 2: JP 2000-503424 A

### DISCLOSURE OF INVENTION

### Problem to be Solved by the Invention

However, since the microlens array disclosed in Patent Document 1 and the lenticular lens array disclosed in Patent Document 2 utilize the effect of refraction of light due to the difference in the refractive index between two materials constituting the lens, chromatic aberration attributed to the wavelength dependence of the refractive index of the materials occurs. The Abbe number of resin materials that can be put to practical use is at most about 50 to 60, and so the chromatic aberration cannot be eliminated by a single refractive lens alone. Thus, the paths of red, green, and blue light rays are displaced from one another, and for this reason, none of the above-described display methods can prevent deterioration in the resolution of a displayed stereoscopic image associated with color misregistration.

Moreover, such a single refractive lens involves so-called field curvature aberration, a phenomenon in which light rays incident on the lens obliquely to the optical axis of the lens form an image at a position closer to the lens than light rays incident on the lens parallel to the optical axis of the lens. In FIG. 12, when attention is paid to the eyeball 102c on the left facing the front surface of the screen 101, a light ray 103R connecting the eye ball 102c and the rightmost portion of the screen 101 forms an extremely large angle with the optical axis of a lenticular lens 104R that the light ray 103R passes through. Therefore, the light ray 103R forms an image at a position closer to the lenticular lens 104R than the surface of the stripe C. In other words, blurring of the image occurs in a right side portion of the screen 101.

In Patent Document 1, spherical aberration, astigmatic aberration, comatic aberration, and so on are reduced by increasing the F number of each lens and decreasing the angle of refraction of light rays in the periphery of the lens. However, there is a problem in that a displayed image inevitably darkens as the F number increases. Also, there is a problem in that a so-called viewing angle, the range of angles at which a stereoscopic image can be viewed well, narrows as the angle of refraction of light rays in the periphery of the lens decreases.

As described above, in conventional stereoscopic image display apparatuses, the problems caused by the lens make it difficult simultaneously to satisfy a high resolution of images, a wide viewing angle of images, and brightness of images.

It is an object of the present invention to provide a stereoscopic image display apparatus that offers a high resolution of images, a wide viewing angle of images, and brightness of images.

### Means for Solving the Problem

The stereoscopic image display apparatus according to the present invention includes a synthetic image formed by synthesizing a plurality of original images from different viewing points, a lens array, and a diffraction element array having the same pitch as the lens array. The diffraction element array has a layer made of a first material and a layer made of a second material and includes a blazed diffraction grating pattern with a depth d that is formed at an interface between the layer made of the first material and the layer made of the second material. When the refractive index of the first material and the refractive index of the second material are expressed as functions of an arbitrary wavelength λ in the visible light range as n1(λ) and n2(λ), respectively, the depth d is substantially equal to λ/|n1(λ)−n2(λ)|.

### EFFECTS OF THE INVENTION

The stereoscopic image display apparatus according to the present invention reduces color misregistration of images associated with chromatic aberration and is therefore capable of displaying high-resolution, wide-viewing-angle, and bright images.

### BRIEF DESCRIPTION OF DRAWINGS

FIG. 1 is a perspective view schematically showing the configuration of a stereoscopic image display apparatus according to Embodiment 1 of the present invention.

FIG. 2 is a fragmentary enlarged cross-sectional view of the stereoscopic image display apparatus according to Embodiment 1 of the present invention.

FIG. 3 is an enlarged cross-sectional view of a portion of a diffraction element in which a blazed diffraction grating pattern is covered with a coating layer.

FIG. 4 is a diagram for explaining the imaging performed by a refractive lens typified by a lenticular lens.

FIG. 5 is a fragmentary enlarged cross-sectional view of a stereoscopic image display apparatus according to Embodiment 2 of the present invention.

FIG. 6 is a fragmentary enlarged cross-sectional view showing a step in the manufacture of a composite element constituting the stereoscopic image display apparatus according to Embodiment 2 of the present invention.

FIG. 7 is a fragmentary enlarged cross-sectional view of a voltage variable lens array constituting a stereoscopic image display apparatus according to Embodiment 3 of the present invention.

FIG. 8A is a cross-sectional view showing a step in a method for manufacturing the voltage variable lens array constituting the stereoscopic image display apparatus according to Embodiment 3 of the present invention.

FIG. 8B is a cross-sectional view showing a step in the method for manufacturing the voltage variable lens array constituting the stereoscopic image display apparatus according to Embodiment 3 of the present invention.

FIG. 8C is a cross-sectional view showing a step in the method for manufacturing the voltage variable lens array constituting the stereoscopic image display apparatus according to Embodiment 3 of the present invention.

FIG. 8D is a cross-sectional view showing a step in the method for manufacturing the voltage variable lens array constituting the stereoscopic image display apparatus according to Embodiment 3 of the present invention.

FIG. 9 is a fragmentary enlarged cross-sectional view of another voltage variable lens array constituting the stereoscopic image display apparatus according to Embodiment 3 of the present invention.

FIG. 10 is a perspective view for explaining the positional relationship between an image and an observer in conventional stereoscopic image display.

FIG. 11 is a diagram for explaining stereoscopic image display by a conventional parallax barrier method.

FIG. 12 is a diagram for explaining stereoscopic image display by a conventional lenticular lens method.

FIG. 13 is a perspective view showing a microlens array used in a conventional integral photography method.

FIG. 14 is a fragmentary enlarged cross-sectional view schematically showing the structure of a conventional lenticular lens array using liquid crystal.

### BEST MODE FOR CARRYING OUT THE INVENTION

In the above-described stereoscopic image display apparatus of the present invention, it is preferable that both of the first material and the second material contain a resin, the second material is made of a composite material containing a resin and inorganic particles, and n1(λ)<n2(λ) is satisfied. Since the first material and the second material contain a resin and the second material is made of the composite material, the processability and productivity of the stereoscopic image display apparatus can be improved. Moreover, a flexible stereoscopic image display apparatus that is resistant to flexure and deflection can be provided.

It is preferable that the second material contains an ultraviolet-curable resin having adhesive properties. This facilitates formation of the diffraction element array and assembly of the stereoscopic image display apparatus.

It is preferable that the lens array is formed in one surface of the layer made of the first material and the blazed diffraction grating pattern is formed in the other surface of the layer made of the first material. This enables reduction of the number of components and the number of assembly steps of the stereoscopic image display apparatus.

It is preferable that the layer made of the first material is made of a thermoplastic material or an ultraviolet-curable material and is molded using a mold. This improves the position accuracy of lenses constituting the lens array and the blazed diffraction grating pattern, resulting in an improvement in the accuracy of assembly.

Hereinafter, preferred embodiments of the present invention will be described with reference to the drawings.

### Embodiment 1

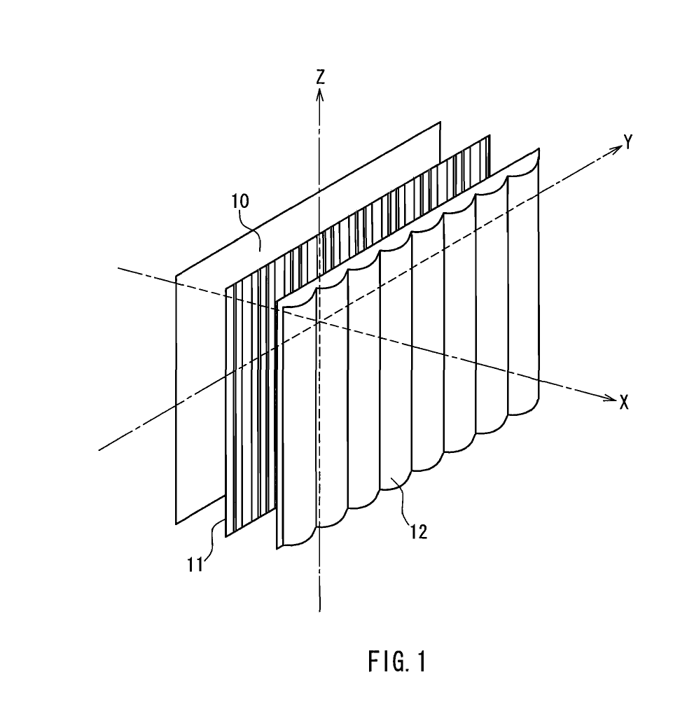

FIG. 1 schematically shows the configuration of a stereoscopic image display device according to Embodiment 1. Reference numeral 10 denotes an image display section formed by synthesizing a plurality of original images from different viewing points, 11 denotes a difffraction element array, and 12 denotes a lenticular lens array. In FIG. 1, the components are illustrated separately. However, a part or all of the components may be in close contact with each other, or may be spaced apart from each other by a predetermined distance. The shape of the lenticular lens array 12 and the shape of the diffraction element array 11 can be optimized in accordance with the arrangement of the components. As shown in FIG. 1, a vertical-direction axis and a horizontal-direction axis that are parallel to the image display section are referred to respectively as the Z axis and the Y axis, and an axis orthogonal to the Z axis and the Y axis is referred to as the X axis. In FIG. 1, a plurality of vertical lines that are illustrated on the diffraction element array 11 and are parallel to the Z axis indicate the position of depths of a blazed diffraction grating pattern in a simplified manner.

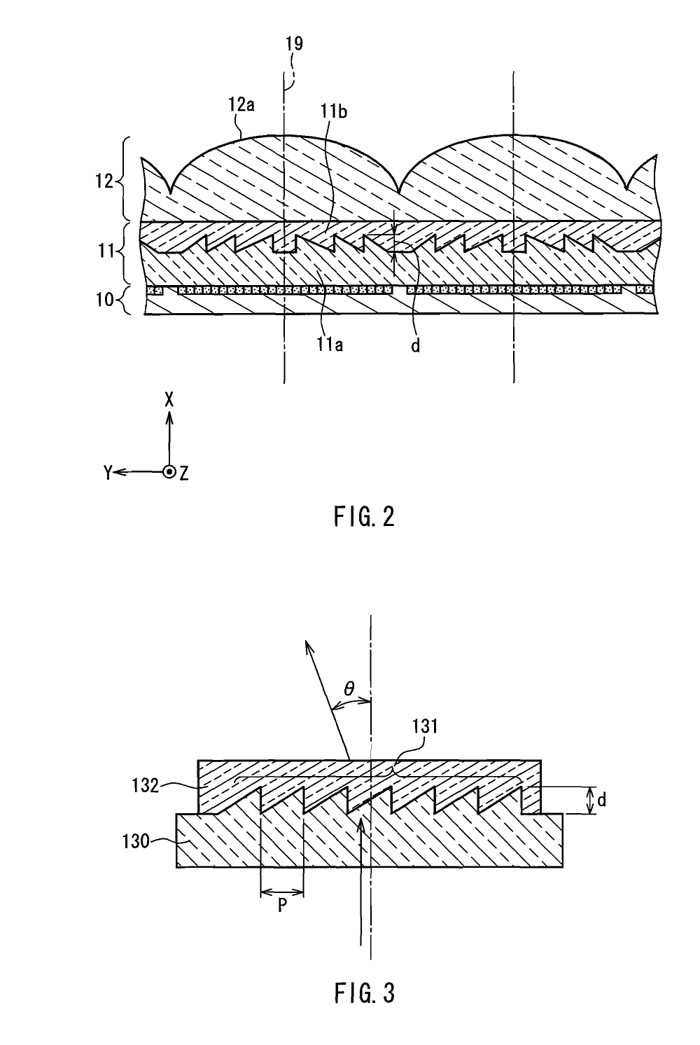

FIG. 2 is a fragmentary enlarged cross-sectional view taken along a plane parallel to an XY plane of the stereoscopic image display apparatus of Embodiment 1. FIG. 2 shows a cross-sectional view of the stereoscopic image display apparatus in which the image display section 10, the diffraction element array 11, and the lenticular lens array 12 are in close contact with each other. The stereoscopic image display apparatus of Embodiment 1 has the same cross-sectional structure at any position in the Z-axis direction.

The diffraction element array 11 and the lenticular lens array 12 are disposed on the image display section 10 in that order.

Lenticular lenses 12a having a substantially cylindrical convex face, the longitudinal direction of which is parallel to the Z axis, are formed in a surface of the lenticular lens array 12 on the opposite side from the diffraction element array 11 in a state in which the lenticular lenses 12a are in close contact with each other in the Y-axis direction.

The diffraction element array 11 is constituted by a base material 11a on the image display section 10 side and a coating layer 11b on the lenticular lens array 12 side. The base material 11a is made of a first material, and the blazed diffraction grating pattern having a depth d is formed in a surface of the base material 11a on the lenticular lens array 12 side. The coating layer 11b is made of a second material and is in close contact with the base material 11a so as to cover the blazed diffraction grating pattern of the base material 11b. The surfaces of the diffraction element array 11 on the image display section 10 side and the lenticular lens array 12 side are both flat and are parallel to each other.

The blazed diffraction grating pattern provided at the interface between the base material 11a and the coating layer 11b contains diffraction grating units that are repeated in the Y-axis direction. The diffraction grating units are arranged repeatedly in the Y-axis direction at the same pitch as the arrangement pitch of the lenticular lenses 12a in the Y-axis direction so as to face the respective lenticular lenses 12a of the lenticular lens array 12. In a single diffraction grating unit, the arrangement distance between the diffraction grating depths in the Y-axis direction is wide in the vicinity of an optical axis 19 of the corresponding lenticular lens 12a and narrows as the distance from the optical axis 19 increases. The depth of the diffraction grating is constant at dirrespective of the position in the Y-axis direction.

In the following, the action of the diffraction element array 11 will be described in detail using the drawings.

FIG. 3 is a cross-sectional view of a diffraction element in which a coating layer 132 is formed so as to cover a blazed diffraction grating pattern 131 formed in the surface of a base material 130. The refractive index of the base material 130 is taken as n1′(λ), and the refractive index of the coating layer 132 is taken as n2′(λ). Here, λ represents the wavelength, and n1′(λ) and n2′(λ) mean that the refractive indices are functions of the wavelength λ.

In the case where light is bent and collected using a diffraction phenomenon for the formation of an image, the first-order diffracted light having high processing robustness and whose properties, such as diffraction efficiency, are less dependent on the wavelength is often used. When the depth of the blazed diffraction grating pattern 131 is taken as d, the condition under which the first-order diffraction efficiency is theoretically 100% with respect to a wavelength λ is expressed by Equation (1) below:

d=λ/|n1′(λ)−n2′(λ)| (1)

When the right side of Equation (1) is a constant value d in a given wavelength band, the first-order diffraction efficiency in that wavelength band is 100% at any wavelength. A large deviation from this condition will result in the occurrence of undesired diffracted light other than the first-order diffracted light, leading to deterioration in contrast and resolution of images. For example, in the case where the coating layer 132 in FIG. 3 is omitted, n2′(λ)=1. Thus, the right side of Equation (1) is not constant when the wavelength λ changes. Ordinary optical materials are high-refractive-index and high-dispersion materials or low-refractive-index and low-dispersion materials. When such a material is used for the base material 130 and the coating layer 132, the first-order diffraction efficiency considerably decreases irrespective of the depth d. Therefore, when a diffraction element in which the blazed diffraction grating pattern 131 of the base material 130 is covered with a coating layer 132 not satisfying the condition of Equation (1) is used as the diffraction grating array 11 of FIGS. 1 and 2, in the case where full-color stereoscopic image display is performed, the image resolution conversely deteriorates due to undesired diffracted light such as the zero-order diffracted light and the second-order diffracted light. What is important is to use a diffraction element array that substantially satisfies Equation (1). For this purpose, the diffraction element array 11 can be configured so that Equation (1) substantially holds in the entire visible range, by combining a high-refractive-index and low-dispersion material and a low-refractive-index and high-dispersion material. Ideally, Equation (1) holds throughout the visible light range. However, there is no problem in practical use as long as Equation (1) substantially holds. Specifically, d/(λ/|n1′(λ)−n2′(λ)|) is preferably between 0.8 and 1.2 inclusive and further preferably between 0.9 and 1.1 inclusive throughout the visible light range.

One merit of combining such a diffraction element with a refractive lens having a spherical or aspherical shape is that chromatic aberration can be reduced.

As shown in FIG. 3, when light rays at a wavelength λ are incident on a diffraction element having a diffraction grating depth pitch P, parallel to the normal of the diffraction element, if Equation (2) is satisfied, all the exiting light rays are the first-order diffracted light rays at a diffraction angle θ.

sin θ=λ/P (2)

However, FIG. 3 shows the case where n2′(λ)>n1′(λ), and in the case where n2′(λ)<n1′(λ), the diffraction direction is reversed from left to right. This also applies to FIG. 2, and the direction of slopes of the blazed diffraction pattern needs to be reversed in accordance with the relationship in magnitude of the refractive index between the base material 11a and the coating layer 11b.

It is clear from Equation (2) that the diffraction angle θ increases as the wavelength λ increases. Thus, in the case where light is collected with a blazed diffraction grating, the longer the wavelength λ is, the closer the light collecting position is to the blazed diffraction grating.

On the other hand, the refractive index of a material decreases as the wavelength increases, and so in the case where light is collected with a refractive lens, the longer the wavelength is, the farther the light collecting position is from the refractive lens. Therefore, when a refractive lens and a blazed diffraction grating are used in combination, variations in the light collecting position due to differences in the wavelength are canceled, and thus the chromatic aberration can be reduced.

Another merit of combining a diffraction element as shown in FIG. 3 with a refractive lens having a spherical or aspherical shape is that the viewing angle can be widened.

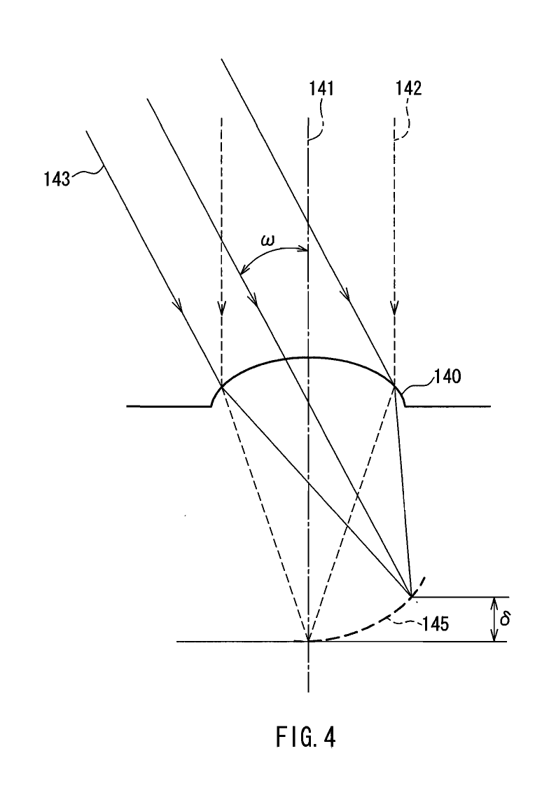

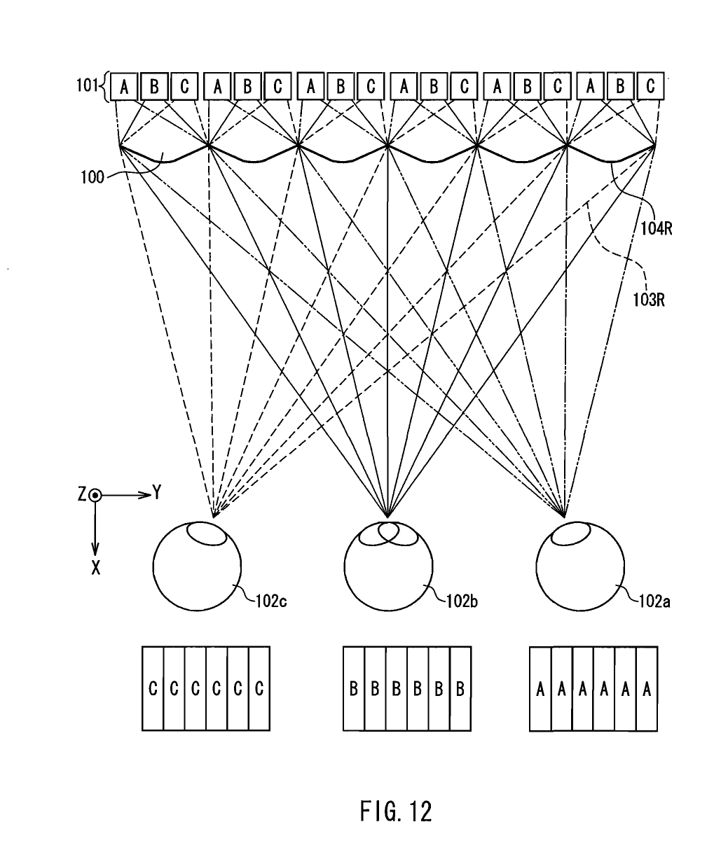

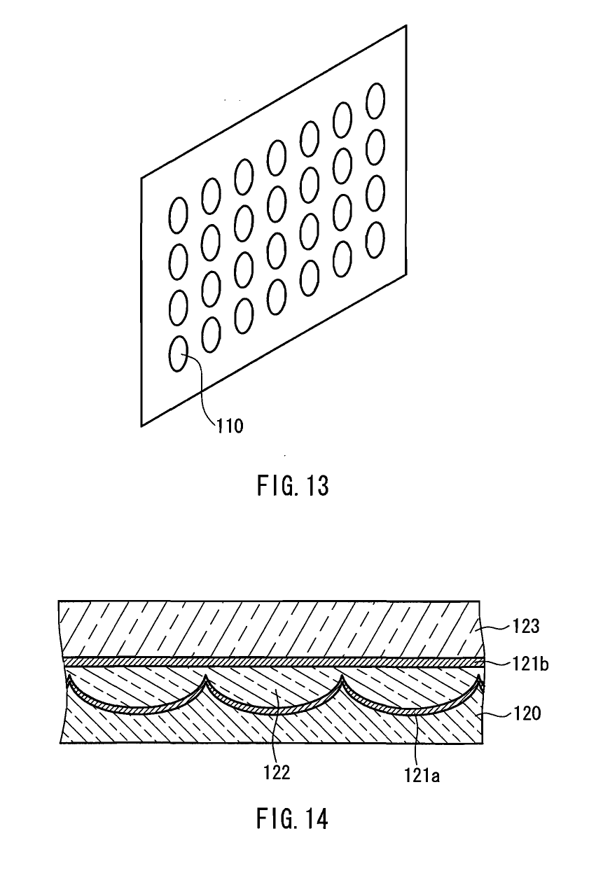

FIG. 4 is a diagram for explaining the imaging performed by a lenticular lens 140, which is a type of refractive lens. The light collecting position of parallel light rays 143 that are incident on the lens 140 at an angle ω relative to the optical axis 141 of the lens 140 is displaced from the light collecting position of parallel light rays 142 that are incident on the lens 140 parallel to an optical axis 141 of the lens 140 toward the lens 140 by an amount δ in the direction of the optical axis 141. When the angle of incidence ω changes, the light collecting position changes along an image plane 145. This phenomenon is not restricted to lenticular lenses and occurs in common refractive lenses, and is called field curvature. The stronger the light collecting ability of a lens is, the greater the field curvature tends to be. When stereoscopic image display as shown in FIG. 12 is performed using a lenticular lens array provided with a lenticular lens having such a property, blurring occurs, resulting in deterioration in the image resolution. Especially in the case where a screen with an enlarged viewing angle is observed obliquely, the degree of deterioration in a displayed image is pronounced.

However, in the case where a refractive lens is combined with a diffraction element having a light collecting ability, a part of the necessary light collecting function can be performed by the diffraction element, so that the light collecting function required for the refractive lens is less than in the case where a refractive lens is used alone. Accordingly, the amount δ of displacement of the light collecting position in FIG. 4 can be decreased. In other words, the field curvature can be reduced. Thus, an optical system with less aberration can be realized without the need to increase the F number, and so a bright image display apparatus can be realized.

As described above, the stereoscopic image display apparatus of Embodiment 1 includes the above-described diffraction element array 11 and lenticular lens array 12 and is therefore capable of displaying high-resolution, wide-viewing-angle, and bright images.

Hereinafter, specific examples associated with Embodiment 1 will be described.

### EXAMPLE 1

An acrylic lenticular lens array 12 in which a plurality of cylindrical lenticular lenses were arranged parallel to the Z axis was used. The arrangement pitch of the lenticular lenses in the Y-axis direction was 2.54 mm ( 1/10 inches), and the focal length was 4 mm. Ten CCD cameras were disposed side by side at distances of 24 mm in the Y-axis direction, and images observed from the positions of the thus prepared ten viewing points were captured and synthesized to obtain a two-dimensional image. This two-dimensional image was printed with an inkjet printer and used as an image display section 10. A diffraction element array 11 and the lenticular lens array 12 were placed accurately on the image display section 10 without misalignment, and thus a stereoscopic image display apparatus was produced.

The diffraction element array 11 was produced by laminating a coating layer 11b made of a urethane acrylate ultraviolet-curable resin (the d-line refractive index after curing was 1.555, and the Abbe number was 38) on a glass base material 11a (material name: K-PSK100 from Sumita Optical Glass, Inc., the d-line refractive index was 1.592, and the Abbe number was 60.5) in one surface of which a blazed diffraction grating pattern having a depth d of 15 μm was formed. In the diffraction element array 11 of Example 1, the glass, which is the material (first material) of the base material 11a, was a high-refractive-index and low-dispersion material and the ultraviolet-curable resin, which is the material (second material) of the coating layer 11b, was a low-refractive-index and high-dispersion material, and Equation (1) above was substantially satisfied in the visible light range. The first-order diffraction efficiency was 96% or more throughout the visible light range (wavelengths from 400 to 700 nm).

The ultraviolet-curable resin has adhesive properties. Therefore, the lenticular lens array 12 and the glass base material 11a were attached together with the ultraviolet-curable resin provided therebetween before curing of the ultraviolet-curable resin, and after positioning of these materials was performed, the ultraviolet-curable resin was cured. Thus, simultaneously with the curing, the lenticular lens array 12 and the diffraction element array 11 were bonded to each other.

Even when the line of sight was moved in the Y-axis direction by large amounts with respect to the stereoscopic image display apparatus produced in this manner, a clear stereoscopic image constantly could be viewed.

### EXAMPLE 2

A lenticular lens array 12 made of cycloolefin (ZEONEX480R, manufactured by Zeon Corporation) and in which a plurality of cylindrical lenticular lenses were arranged parallel to the Z axis was used. The arrangement pitch of the lenticular lenses in the Y-axis direction was 2.54 mm ( 1/10 inches), and the focal length was 4 mm. Ten CCD cameras were disposed side by side at distances of 24 mm in the Y-axis direction, and images observed from the positions of the thus prepared ten viewing points were captured and synthesized to obtain a two-dimensional image. This two-dimensional image was printed with an inkjet printer and used as an image display section 10. A diffraction element array 11 and the lenticular lens array 12 were placed accurately on the image display section 10 without misalignment, and thus a stereoscopic image display apparatus was produced.

A composite material containing a resin mainly composed of polycarbonate and zinc oxide (the composite material had a d-line refractive index of 1.683 and an Abbe number of 18.9, the zinc oxide content in the composite material was 30 vol %, and the average particle size of zinc oxide was 10 nm) was used as the material (first material) of a base material 11a of the diffraction element array 11, and a blazed diffraction grating pattern having a depth of 5.2 μm was formed in one surface of the composite material.

The above-described “resin mainly composed of polycarbonate” had a polycarbonate content of 97 wt %. However, the present invention is not limited to this, and the polycarbonate content is preferably 95 wt % or more and further preferably 98 wt % or more. Moreover, in Example 2, polycarbonate was used as the resin contained as the main component. However, this is not a limitation, and any resin can be used as long as it has a desired refractive index. For example, polyethylene, polystyrene, or the like also may be used. Furthermore, although zinc oxide was used as inorganic particles in Example 2, this is not a limitation, and any material can be used as long as it has a desired refractive index. For example, metallic oxides such as titanium oxide, tantalum oxide, zirconium oxide, aluminum oxide, yttrium oxide, silicon oxide, niobium oxide, cerium oxide, indium oxide, tin oxide, and hafium oxide can be used.

A composite material containing a resin mainly composed of a cycloolefin resin and zirconium oxide (the composite material had a d-line refractive index of 1.796 and an Abbe number of 41.9, the zirconium oxide content in the composite material was 50 vol %, and the average particle size of zirconium oxide was 10 nm) was used as the material (second material) of a coating layer 11b of the diffraction element array 11. This material was applied by the bar coating method to the surface of the base material 11a in which the blazed diffraction grating pattern was formed, and thus the coating layer 11b was formed.

The above-described “resin mainly composed of a cycloolefin resin” had a cycloolefin resin content of 92 wt %. However, the present invention is not limited to this, and the cycloolefin resin content is preferably 90 wt % or more and further preferably 95 wt % or more. Moreover, in Example 2, the cycloolefin resin was used as the resin contained as the main component. However, this is not a limitation, and any resin can be used as long as it has a desired refractive index. For example, polyethylene, polystyrene, or the like also may be used.

In the diffraction element array 11 of Example 2, the composite material constituting the base material 11a was a low-refractive-index and high-dispersion material and the composite material constituting the thin film layer 11b was a high-refractive-index and low-dispersion material, and Equation (1) above substantially was satisfied in the visible light range.

The lenticular lens array 12 and the diffraction element array 11 were attached together via an ultraviolet-curable resin having a predetermined thickness.

Even when the line of sight was moved in the Y-axis direction by large amounts with respect to the stereoscopic image display apparatus produced in this manner, a clear stereoscopic image constantly could be viewed.

In Example 2, both of the diffraction element array 11 and the lenticular lens array 12 are made of a material mainly composed of a resin, so that the processability is good and the productivity can be improved. Moreover, a flexible stereoscopic image display apparatus that is resistant to flexure and deflection can be realized.

### Embodiment 2

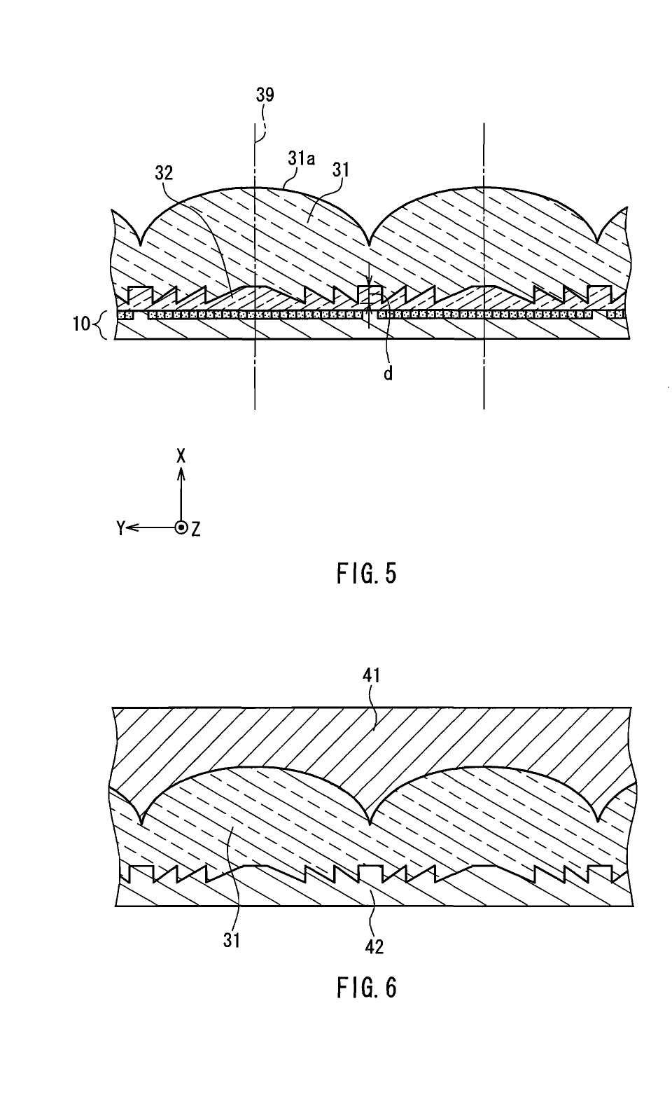

FIG. 5 is a fragmentary enlarged cross-sectional view of a stereoscopic image display apparatus of Embodiment 2 taken along a plane parallel to the XY plane. In Embodiment 2, a composite element 31 in which a lenticular lens array is formed in one surface and a blazed diffraction grating pattern is formed in the other surface is integrated with an image display section 10 in close contact with each other via a thin film layer 32. The stereoscopic image display apparatus of Embodiment 2 has the same cross-sectional structure at any position in the Z-axis direction.

In the lenticular lens array formed in one surface of the composite element 31, lenticular lenses 31a having a substantially cylindrical convex face, the longitudinal direction of which is parallel to the Z-axis, are formed in close contact with each other in the Y-axis direction.

The blazed diffraction grating pattern formed in the other surface (i.e., the surface on the image display section 10 side) of the composite element 31 is constituted by diffraction grating units that are repeated in the Y-axis direction. The diffraction grating units are arranged repeatedly in the Y-axis direction at the same pitch as the arrangement pitch of the lenticular lenses 31a in the Y-axis direction so as to face the respective lenticular lenses 31a of the lenticular lens array. In a single diffraction grating unit, the arrangement distance between diffraction grating depths in the Y-axis direction is wide in the vicinity of an optical axis 39 of the corresponding lenticular lens 31a and narrows as the distance from the optical axis 39 increases. The depth of the diffraction grating is constant at d irrespective of the position in the Y-axis direction.

The thin film layer 32 is in close contact with the composite element 31 so as to cover the blazed diffraction grating pattern of the composite element 31. The composite element 31 is made of a first material, and the thin film layer 32 is made of a second material. In the visible light range, the first material and the second material substantially satisfy Equation (1) above. Therefore, a diffraction element array formed at the interface between the composite element 31 and the thin film layer 32 have the same functions as the diffraction element array described in Embodiment 1.

FIG. 6 is a fragmentary enlarged cross-sectional view showing a step in the manufacture of the composite element 31. In FIG. 6, reference numerals 41 and 42 denote a cope and a drag constituting a resin mold used in injection molding. A thermoplastic resin is used as the first material constituting the composite element 31. The thermoplastic resin is melted into a liquid form at a high temperature and thereafter injected between the cope 41 and the drag 42 that are clamped. The resin is molded into the shape of the composite element 31 by the cope 41 and the drag 42 having a lower temperature than the resin and stabilized. After cooling, the resin is removed from the mold. Such injection molding is used widely as a lens manufacturing method, and is most productive and is capable of securing a highly precise shape. In the foregoing, an ultraviolet-curable resin also can be used as the first material constituting the composite element 31. In this case, the ultraviolet-curable resin can be cured using a cope 41 and a drag 42 made of a material that transmits ultraviolet light rays. However, the method for manufacturing the composite element 31 is not limited to this. For example, a method of transferring a desired shape onto the surface of a moving long material using a roller (roll forming), a method of transferring a shape given to upper and lower molds to a material (press forming), and so on also can be used.

In Embodiment 2, the lenticular lenses and the blazed diffraction grating pattern are formed respectively in the front and back surfaces of the composite element 31. Therefore, the number of components and the number of assembly steps can be reduced when compared with the case where the lenticular lenses and the blazed diffraction grating pattern are formed in separate components as described in Embodiment 1. Moreover, relative alignment of the lenticular lenses and the blazed diffraction grating pattern is performed easily, and thus the accuracy of assembly is improved. In particular, when the cope 41 and the drag 42 in FIG. 6 are aligned in a frame (not shown) and injection molding is performed in this state, the relative position accuracy of the lenticular lenses in one surface and the blazed diffraction grating pattern in the other surface can be secured with an error of only several micrometers or less. Therefore, the lenticular lenses and the blazed diffraction grating pattern can be aligned with high accuracy.

The stereoscopic image display apparatus of Embodiment 2 provides the same effects as Embodiment 1, reduces chromatic aberration and field curvature, which are problems with conventional stereoscopic image display apparatuses having a lenticular lens array, and is capable of displaying high-resolution, wide-viewing-angle, and bright images.

Hereinafter, a specific example associated with Embodiment 2 will be described.

### EXAMPLE 3

A composite element 31 made of a polycarbonate (the d-line refractive index was 1.585, and the Abbe number was 28) and in which a plurality of cylindrical lenticular lenses were arranged parallel to the Z axis in one surface and a blazed diffraction grating was formed in the other surface was used. The arrangement pitch of the lenticular lenses in the Y-axis direction was 2.54 mm ( 1/10 inches), and the focal length was 4 mm. The depth d of the blazed diffraction element was 15 μm. The composite element 31 was produced by injecting a polycarbonate resin heated to about 290° C. into a mold having a temperature of 110° C. and molding the resin. The mold was produced by cutting with a cutting tool.

Ten CCD cameras were disposed side by side at distances of 24 mm in the Y-axis direction, and images observed from the positions of the thus prepared ten viewing points were captured and synthesized to obtain a two-dimensional image. This two-dimensional image was printed with an inkjet printer and used as an image display section 10. An ultraviolet-curable resin (the d-line refractive index after curing was 1.623, and the Abbe number was 40) in which nanoparticles of zirconium oxide were dispersed was provided on the image display section 10 as the material of a thin film layer 32, and the composite element 31 was placed accurately on the ultraviolet-curable resin without misalignment of the composite element 31 with respect to the image display section 10. Then, the ultraviolet-curable resin was cured, and thus a stereoscopic image display apparatus was produced. In Example 3, the first material constituting the composite element 31 was a low-refractive-index and high-dispersion material and the second material constituting the thin film layer 32 was a high-refractive-index and low-dispersion material, and Equation (1) above was substantially satisfied in the visible light range. The first-order diffraction efficiency was 96% or more throughout the visible light range (wavelengths from 400 to 700 nm).

Even when the line of sight was moved in the Y-axis direction by large amounts with respect to the stereoscopic image display apparatus produced in this manner, a stereoscopic image constantly could be viewed clearly.

### Embodiment 3

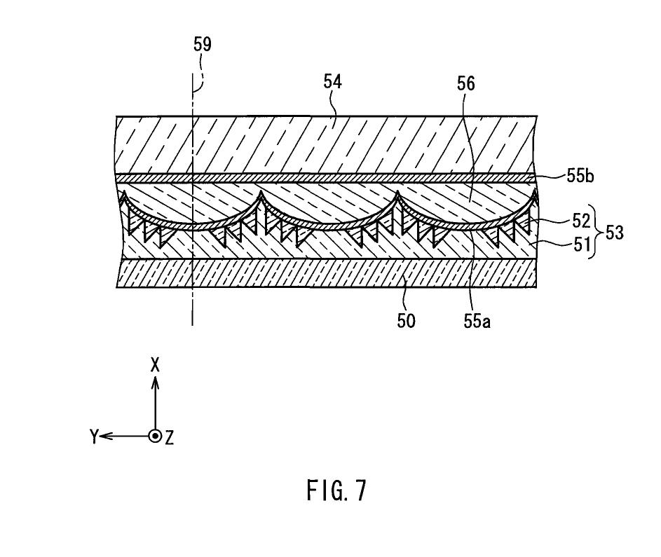

FIG. 7 is a fragmentary enlarged cross-sectional view of a voltage variable lens constituting a stereoscopic image display apparatus of Embodiment 3. A composite member 53 is laminated on a first transparent substrate 50. The composite member 53 includes a first member 51 made of a transparent, first material and a second member 52 made of a second material different from the first material. A lenticular lens array in which lenticular lenses having a substantially cylindrical concave face extending in a direction parallel to the Z axis are formed in close contact with each other in the Y-axis direction is formed in a surface of the first material 51 on the opposite side from the first transparent substrate 50. A blazed diffraction grating pattern is formed in the surface of each lenticular lens. Grooves of the blazed diffraction grating pattern is filled with the second member 52 made of the second material. In a single lenticular lens, the arrangement distance between diffraction grating depths in the Y-axis direction is wide in the vicinity of an optical axis 59 of the lenticular lens and narrows as the distance from the optical axis 59 increases. The depth of the diffraction grating is constant at d irrespective of the position in the Y-axis direction.

A display element (not shown) that performs a predetermined display is disposed on a side of the first transparent substrate 50 opposite from the composite member 53.

In the visible light range, the first material and the second material substantially satisfy Equation (1) above. Therefore, a diffraction element array formed at the interface between the first member 51 and the second member 52 has the same functions as the diffraction element array described in Embodiment 1.

For example, when a polycarbonate having a d-line refractive index of 1.585 and an Abbe number of 28 is used as the first material, an ultraviolet-curable resin (the d-line refractive index after curing is 1.623, and the Abbe number is 40) in which nanoparticles of zirconium oxide are dispersed is used as the second material, and the depth d of the blazed diffraction grating is set to 15 μm, the first-order diffraction efficiency is 96% or more throughout the visible light range (wavelengths from 400 to 700 nm).

A second transparent substrate 54 faces the surface of the composite member 53 on the opposite side from the first transparent substrate 50. Transparent electrode layers 55a and 55b are formed respectively on the surfaces of the composite member 53 and the second transparent substrate 54 facing each other. The space between the transparent electrode layer 55a and the transparent electrode layer 55b is filled with a liquid crystal material 56. The lens action of the lenticular lenses can be switched by controlling the electric potential difference between the transparent electrode layer 55a and the transparent electrode layer 55b.

A nematic liquid crystal, for example, whose d-line refractive index is 1.7 in the case where a potential difference is applied across the transparent electrode layer 55a and the transparent electrode layer 55b (hereinafter, this state is referred to as an “‘on’ mode”) and is 1.5 in the case where the transparent electrode layer 55a and the transparent electrode layer 55b are at the same electric potential (hereinafter, this state is referred to as an “‘off’ mode”) can be used preferably as the liquid crystal material 56.

In the case where the above-described nematic liquid crystal is used as the liquid crystal material 56 and a polycarbonate having a d-line refractive index of 1.585 and an Abbe number of 28 is used as the material of the first member 51, a refractive lens formed by the liquid crystal material 56 and the first member 51 has a negative light-collecting power (i.e., diverges parallel light rays) in the “off” mode. On the other hand, a diffractive lens formed by the blazed diffraction grating that is formed at the interface between the first member 51 and the second member 52 has a positive light-collecting power (i.e., converges parallel light rays). Therefore, the entire voltage variable lens array in FIG. 7 functions as merely a transparent parallel plate, and the observer can observe the display of the display element disposed under the transparent substrate 50 as it is. Accordingly, in the “off” mode, the image display apparatus of this embodiment functions as an ordinary two-dimensional image display apparatus by making the display element display a two-dimensional image.

On the other hand, in the “on” mode, the relationship in magnitude of the refractive index between the liquid crystal material 56 and the first member 51 is reversed from that in the above-described “off” mode, and the refractive lens formed by the liquid crystal material 56 and the first member 51 has a positive light-collecting power. The positive light-collecting power of the diffractive lens formed by the blazed diffraction grating that is formed at the interface between the first member 51 and the second member 52 is superimposed on this positive light-collecting power. Therefore, the entire voltage variable lens array in FIG. 7 functions as a lens array having a positive light-collecting power. Accordingly, in the “on” mode, the image display apparatus of this embodiment functions as a stereoscopic image display apparatus by making the display element disposed under the transparent substrate 50 display a synthesized image formed by synthesizing a plurality of original images from different viewing points.

The stereoscopic image display apparatus of Embodiment 3 has the same effects as those of Embodiments 1 and 2 above, reduces chromatic aberration and field curvature, which are problems with conventional stereoscopic image display apparatuses using a liquid crystal lens, and can provide high-resolution, wide-viewing-angle, and bright images.

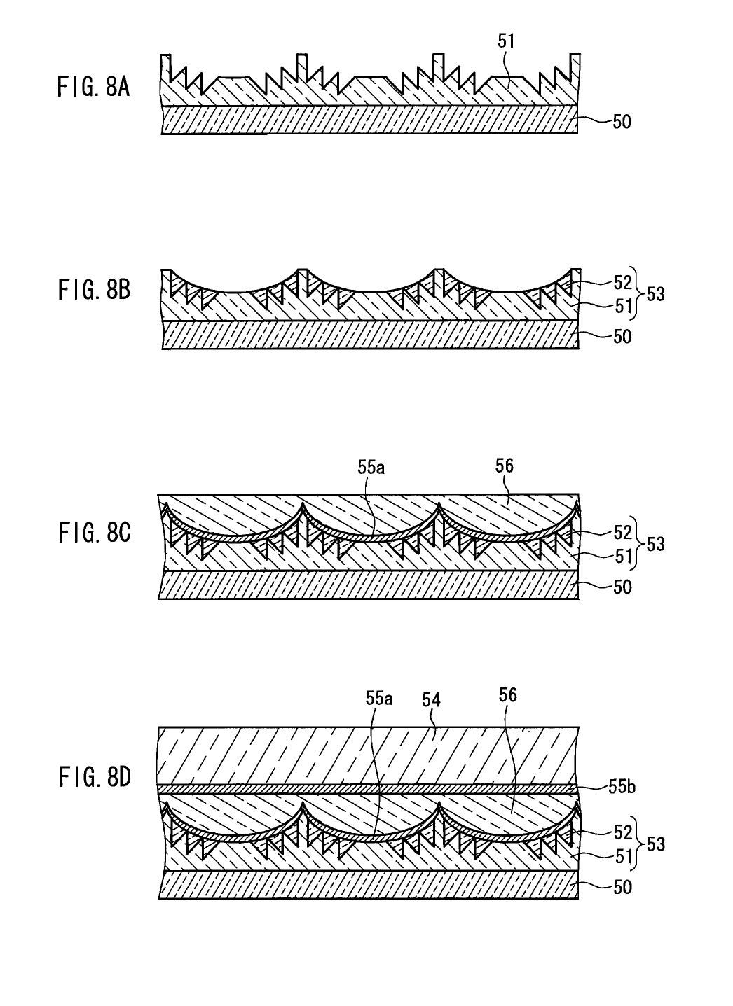

FIGS. 8A to 8D are fragmentary enlarged cross-sectional views sequentially showing steps of a method for manufacturing the voltage variable lens array that is shown in FIG. 7 and has the diffraction element array therein. The manufacturing method of the voltage variable lens array will be described using FIGS. 8A to 8D.

First, as shown in FIG. 8A, the first member 51 is provided on the first transparent substrate 50. For example, an uncured first material is provided on the first transparent substrate 50, a lenticular lens pattern (substantially cylindrical concave faces) and grooves of a blazed diffraction grating pattern are transferred onto a surface of the first material by pressing a mold, and thereafter the first material is cured.

Next, as shown in FIG. 8B, the second material serving as the second member 52 is charged (embedded) into the grooves of the blazed diffraction grating pattern of the first member 51. For example, a method of applying an uncured second material onto the first member 51, removing an excess of the second material with a squeegee, and thereafter, curing the second material can be used as the charging method. In this manner, the composite member 53 is formed on the first transparent substrate 50.

For example, thermoplastic resins such as polycarbonate, ultraviolet-curable resins such as acrylic, epoxy, or silicon ultraviolet-curable resins, or composite materials in which an inorganic material is dispersed in these resins can be used as the first material and the second material. The first material and the second material can be selected so as to substantially satisfy Equation (1) above in the visible light range.

Then, as shown in FIG. 8C, the transparent electrode layer 55a is formed on the composite member 53, and furthermore, the liquid crystal material 56 is applied thereto. For example, a material mainly composed of ITO can be used as the transparent electrode layer 55a. The alignment direction of the liquid crystal material 56 is controlled by rubbing the transparent electrode layer 55a before the application of the liquid crystal material 56.

Finally, as shown in FIG. 8D, the second transparent substrate 54 on one surface of which the transparent electrode layer 55b is formed is laminated with the transparent electrode layer 55b on the liquid crystal material 56 side, thereby sealing the liquid crystal material 56. For example, a material mainly composed of ITO can be used as the transparent electrode layer 55b. Thus, the voltage variable lens array shown in FIG. 7 is completed.

As described above, although the voltage variable lens array constituting the stereoscopic image display apparatus of Embodiment 3 includes the diffraction element array constituted by the blazed diffraction grating, the voltage variable lens array can be produced by almost the same method as conventional voltage variable lens arrays.

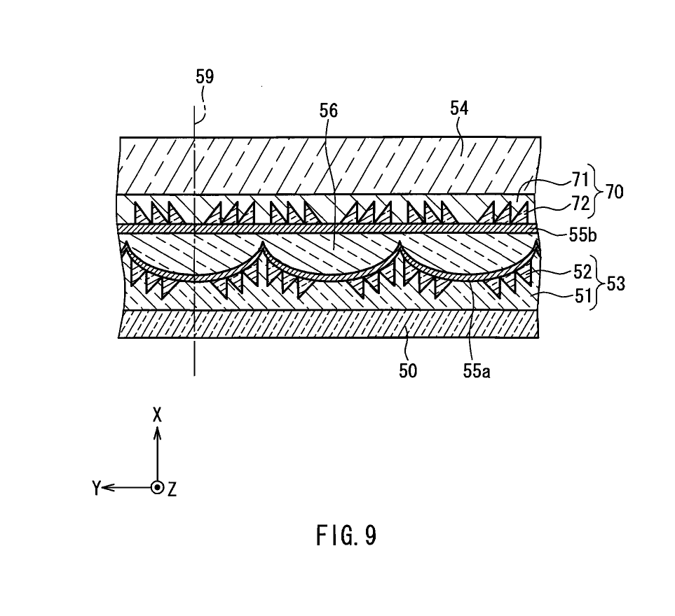

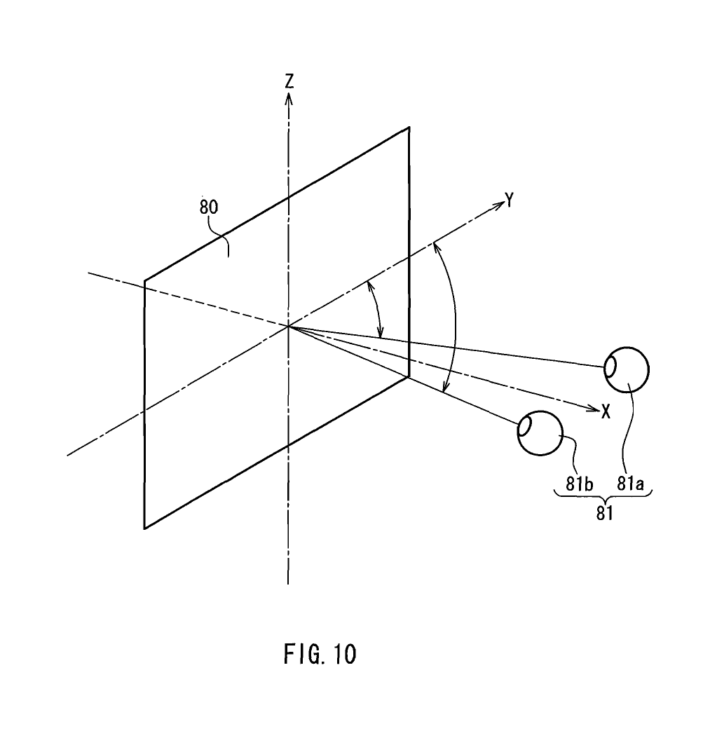

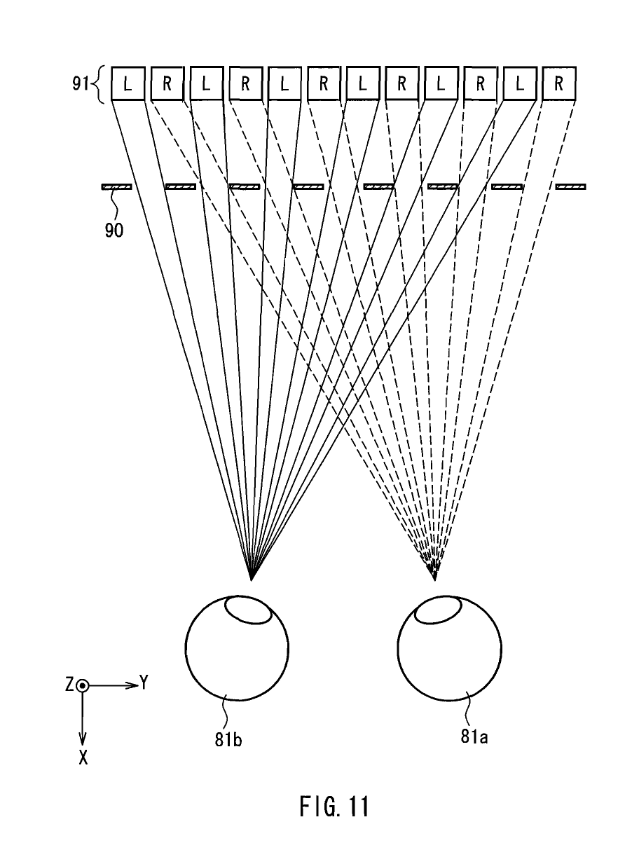

As shown in FIG. 9, a second composite member 70 in which a diffraction element array is formed also may be provided between the liquid crystal material 56 and the second transparent substrate 54. The second composite member 70 includes a first member 71 made of a transparent, first material and a second member 72 made of a second material different from the first material. A blazed diffraction grating pattern is formed in a surface of the first member 71 on the opposite side from the second transparent substrate 54. Grooves of the blazed diffraction grating pattern are filled with the second member 72 made of the second material. In a region corresponding to a single lenticular lens, the arrangement distance between diffraction grating depths formed in the second composite member 70 in the Y-axis direction is wide in the vicinity of the optical axis 59 of the lenticular lens and narrows as the distance from the optical axis 59 increases. The transparent electrode layer 55b is provided on the second composite member 70. More favorable stereoscopic image display can be achieved by disposing two diffraction element array layers in the X-axis direction in this manner. The materials of the first member 71 and the second member 72 and the manufacturing method of the second composite member 70 can be the same as those in the case of the composite member 53.

FIG. 9 shows an example in which two diffraction element array layers are disposed in the X-axis direction. However, three or more diffraction element array layers also may be disposed in the X-axis direction.

Moreover, in FIG. 9, a voltage variable lens array in which the blazed diffraction grating pattern is not formed in the first member 51 and the diffraction element array is provided only in the second composite member 70 also can be used. Also in this case, the voltage variable lens array has the same effects as the voltage variable lens array shown in FIG. 7 because the voltage variable lens array includes one diffraction element array layer.

The embodiments described above are solely intended to elucidate the technological content of the present invention, and the present invention is not limited to or by these specific examples alone. Various modifications are possible within the scope of the claims and the spirit of the invention, and the present invention should be interpreted broadly.

### INDUSTRIAL APPLICABILITY

The stereoscopic image display apparatus of the present invention reduces color misregistration of images associated with chromatic aberration and is therefore capable of displaying high-resolution, wide-viewing-angle, and bright images. Thus, the stereoscopic image display apparatus can be used, as various display apparatuses that are required to display a stereoscopic image, in a wide range of applications from portable device applications, such as mobile telephones, having relatively small screens to television applications having large screens. Moreover, the stereoscopic image display apparatus can be used not only in moving image applications but also in still image applications such as printed matters that need stereoscopic image display.

1. A stereoscopic image display apparatus comprising a synthetic image formed by synthesizing a plurality of original images from different viewing points, a lens array, and a diffraction element array having the same pitch as the lens array,
wherein the diffraction element array has a layer made of a first material and a layer made of a second material and comprises a blazed diffraction grating pattern with a depth d that is formed at an interface between the layer made of the first material and the layer made of the second material; and
when the refractive index of the first material and the refractive index of the second material are expressed as functions of an arbitrary wavelength λ in the visible light range as n1(λ) and n2(λ), respectively, the depth d is substantially equal to λ/|n1(λ)−n2(λ)|.

2. The stereoscopic image display apparatus according to claim 1, wherein both of the first material and the second material contain a resin, the second material is made of a composite material containing a resin and inorganic particles, and n1(λ)<n2(λ) is satisfied.

3. The stereoscopic image display apparatus according to claim 2, wherein the second material contains an ultraviolet-curable resin having adhesive properties.

4. The stereoscopic image display apparatus according to claim 1, wherein the lens array is formed in one surface of the layer made of the first material, and the blazed diffraction grating pattern is formed in the other surface of the layer made of the first material.

5. The stereoscopic image display apparatus according to claim 4, wherein the layer made of the first material is made of a thermoplastic material or an ultraviolet-curable material and is molded using a mold.
